(19) United States
(12) Patent Application Publication
(10) Pub. No.: US 2025/0179740 A1
(43) Pub. Date: Jun. 5, 2025

(54) IMPROVED HYDRAULIC SYSTEM FOR VIBRATION GENERATION

(71) Applicant: POCLAIN HYDRAULICS INDUSTRIE, Verberie (FR)

(72) Inventor: Jean Heren, Verberie (FR)

(73) Assignee: POCLAIN HYDRAULICS INDUSTRIE, Verberie (FR)

(21) Appl. No.: 18/862,018

(22) PCT Filed: Apr. 28, 2023
(86) PCT No.: PCT/FR2023/000064

§ 371 Date: Oct. 31, 2024

(30) Foreign Application Priority Data
May 2, 2022 (FR) FR2204135

(51) Int. Cl. E01C 19/28

(52) U.S. Cl. CPC E01C 19/286

(57) ABSTRACT

System for driving a compactor, including a variable displacement primary pump, a variable displacement secondary pump, an electric motor, adapted to jointly drive in rotation the primary pump and the secondary pump, a controller, adapted to pilot the primary motor so as to provide sufficient torque to drive the primary pump and the secondary pump.

### TECHNICAL FIELD

The present invention relates to a hydraulic circuit for an electric compactor.

### PRIOR ART

The generation of vibration in a machinery or equipment such as an electric compactor meets specific constraints, which lead to the creation of dedicated circuits.

The conventional circuits for the generation of vibration commonly use a hydraulic pump supplying one or more hydraulic motors to drive one or more eccentric rotating masses forming an unbalance, via an all-or-nothing type selector.

It is important to obtain a rapid launch and a rapid shutdown of the vibrating masses so that the number of cycles per length unit traveled is as constant as possible over a working length of the compactor, in order not to deform the surface to be compacted. It is also important to achieve the working frequencies for which the machine is designed, particularly concerning the masses of the subassemblies subjected to vibration and the stiffnesses of the assembly elements, in order to avoid unwanted resonance phenomena of the structures of the machine.

Conventional circuits have complex structures implementing a multitude of components, which is penalizing in terms of cost, mass, space requirement, energy savings and autonomy.

Document US2021047790 presents an example of a known system aimed at improving the retaining effect of a compactor, in particular downhill. This document proposes to actuate the rotating masses either intermittently or alternately in both directions of rotation in order to generate additional inertia and generate a braking effect. It is however understood that the commissioning of the rotating masses in this way over a working length is not acceptable due to the deformations caused on the ground of a construction site.

The present invention thus aims to at least partially address these issues.

### DISCLOSURE OF THE INVENTION

The present invention thus proposes a system for driving a compactor, comprising:
a primary pump, adapted to supply a primary hydraulic circuit,
a secondary pump, adapted to supply a secondary hydraulic circuit,
an electric motor, adapted to jointly drive in rotation the primary pump and the secondary pump,
in which
the primary pump and the secondary pump are variable displacement hydraulic pumps,
the primary hydraulic circuit is adapted to perform a rotation of movement members of the compactor, said movement members comprising at least one roller, the primary pump being a variable displacement hydraulic pump, the secondary hydraulic circuit is adapted to perform a rotation of vibrating elements adapted to generate vibrations, the secondary pump being a variable displacement hydraulic pump,
the system comprises a controller, adapted to pilot the primary motor so as to provide sufficient torque to drive the primary pump and the secondary pump.

According to one example, the primary hydraulic circuit is a closed-loop circuit, the secondary hydraulic circuit is a closed-loop circuit.

According to one example, the secondary hydraulic circuit comprises a calibrated relief member, adapted to perform a pressure relief from a duct of the secondary hydraulic circuit to a duct of the secondary hydraulic circuit having a lower pressure or to a reservoir, said calibration member being in the on-state when the pressure is greater than or equal to a calibration pressure, and in which the controller is configured to pilot the primary motor and the secondary pump such that the pressure in the secondary circuit remains lower than the calibration pressure.

According to one example, the controller is configured to pilot the primary motor and the secondary pump such that the pressure in the secondary circuit remains lower than the calibration pressure while maintaining a constant movement speed of the compactor.

According to one example, the controller is configured to pilot the primary motor, the primary pump and the secondary pump such that the vibrating elements are driven in the same direction of rotation as the movement members, typically continuously.

According to one example, the controller is configured to pilot the rotational speed of the primary motor, the displacement of the primary pump and the displacement of the secondary pump.

According to one example, the system further comprises a booster pump adapted to supply a booster circuit, the primary motor being adapted to drive in rotation the booster pump together with the primary pump and the secondary pump.

The system can then comprise a braking member disposed at a discharge of the booster pump, the braking member being adapted to be in the on-state or to define a restriction at the discharge of the booster pump, so as to generate a resistive torque on a shaft of the primary motor driving in rotation the booster pump, the primary pump and the secondary pump.

According to one example, the braking member is a flow rate limiter having a fixed adjustment defining a flow rate beyond which it is in the on-state, said adjustment being set to a value greater than a pressure value corresponding to nominal operation of the system.

The present invention also relates to a method for piloting a system, comprising:
a primary hydraulic circuit adapted to drive in rotation movement members of a compactor comprising at least one roller, said primary hydraulic circuit comprising a variable displacement hydraulic primary pump,
a secondary hydraulic circuit adapted to drive in rotation vibrating elements to generate vibrations, said secondary hydraulic circuit comprising a variable displacement hydraulic secondary pump,
an electric primary motor, adapted to jointly drive in rotation the primary pump and the secondary pump,
said method being characterized in that the primary motor is piloted so as to provide sufficient torque to jointly drive in rotation the primary pump and the secondary pump.

According to one example, the rotational speed of the primary motor, the displacement of the primary pump and the displacement of the secondary pump are piloted.

According to one example, the primary motor is piloted so that the pressure in the secondary hydraulic circuit remains lower than a calibration pressure of a relief member, said relief member being adapted to be in the on-state and to perform a flow rate leak when the pressure in the secondary hydraulic circuit is higher than said calibration pressure.

According to one example, the primary motor is also piloted so as to drive in rotation a booster pump of a booster circuit jointly with the primary pump and the secondary pump.

According to one example, a braking member is provided at the discharge of the booster pump, so as to selectively generate a resistive torque on the primary motor.

According to one example, the braking member is a flow rate limiter having a fixed adjustment defining a flow rate beyond which it is in the on-state, and in which said adjustment is set to a value greater than a pressure value corresponding to nominal operation of the system.

### BRIEF DESCRIPTION OF THE DRAWINGS

The invention and its advantages will be better understood upon reading the detailed description given below of different embodiments of the invention given as non-limiting examples.

FIG. 1 is a schematic representation of a system according to one aspect of the invention.

FIG. 2 is a more detailed representation of FIG. 1.

FIG. 3 is a graph which represents the evolution of parameters of the circuit during its use.

In all the figures, the elements in common are identified by identical numerical references.

### DESCRIPTION OF THE EMBODIMENTS

The figures represent one example of a system according to one aspect of the invention.

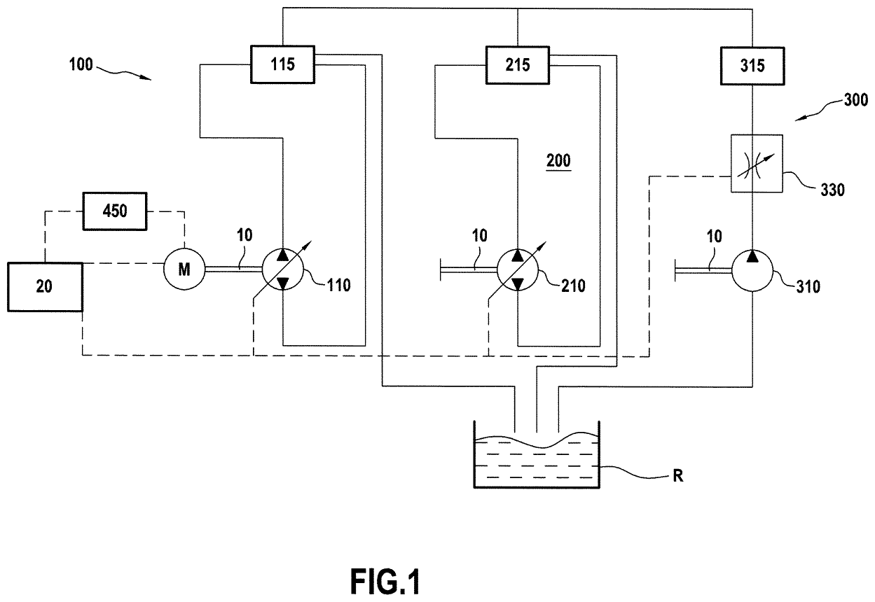

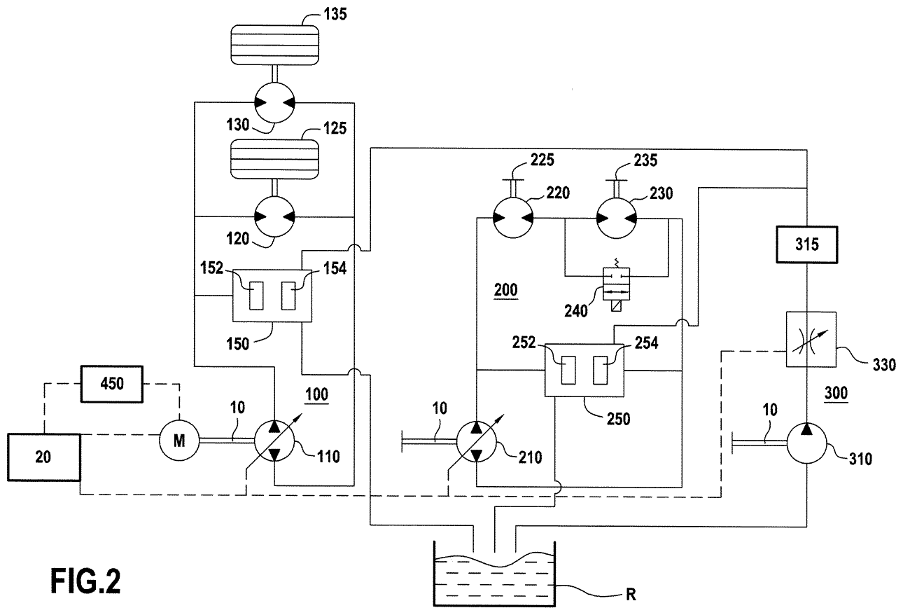

FIGS. 1 and 2 schematically illustrate two representations of a system according to one aspect of the invention.

The system as represented comprises a traction circuit or primary circuit 100, a vibration circuit or secondary circuit 200 and an optional booster circuit 300.

The primary circuit 100 comprises a primary pump 110 adapted to supply one or more hydraulic motors adapted to drive in rotation movement members of a compactor. The primary pump 110 is a variable displacement hydraulic pump. In the example illustrated in FIG. 2, the hydraulic pump 110 is connected to two hydraulic motors 120 and 130 adapted to drive in rotation movement members of a vehicle or machinery, respectively 125 and 135, for example balls or rollers. The nature of the movement members varies according to the nature of the machinery, in particular whether it is a simple compactor, therefore with a single roller and an axle equipped with wheels, or a tandem compactor with two rollers. The primary circuit 100 as represented is a closed-loop hydraulic circuit.

The secondary circuit 200 comprises a secondary pump 210 connected to two hydraulic motors 220 and 230 adapted to drive in rotation elements adapted to generate vibrations, for example eccentric masses. The secondary pump 210 is a variable displacement hydraulic pump.

In the example illustrated, the secondary circuit 200 thus comprises two hydraulic motors 220 and 230 adapted to drive in rotation two vibrating elements, respectively 225 and 235, which typically corresponds to a tandem compactor comprising two rollers. It is understood that in the case of a compactor comprising a single roller, the secondary circuit 200 can then comprise only a single hydraulic motor driving in rotation a single vibrating element.

In the example illustrated, a bypass valve 240 is mounted in parallel with the hydraulic motor 230, which thus makes it possible to activate either the two hydraulic motors 220 and 230, or only the hydraulic motor 220. The bypass valve 240 is typically an electrically-controlled valve.

The secondary circuit 200 as illustrated is a closed-loop hydraulic circuit.

The system comprises an electric primary motor M. The primary motor M has a driving shaft 10 adapted to jointly drive in rotation the primary pump 110 and the secondary pump 210. The two pumps 110 and 210 are for example coupled to the same shaft 10 of the primary motor M. In the figures, for the clarity of the drawings, the shaft 10 is represented partially, that is to say in an interrupted manner along its length. The primary motor M is coupled to a current storage means 450 such as a battery.

The primary pump 110 may for example be a through-shaft pump so as to allow the secondary pump 210 to be coupled. Alternatively, each pump contains a shaft portion and an attachment between the primary pump 110 and the secondary pump 210, for example a concentric interlocking of the shafts, with splines, or a planar coupling, or a universal joint or Oldham joint. Alternatively, the primary motor M can be associated with the primary pump 110 and with the secondary pump 210 via a parallel mounting, for example with a connection by belts, a chain or gears which performs a joint driving by the primary motor M.

Thus, in operation, the primary motor M will drive in rotation both the primary pump 110 and the secondary pump 210, so as to allow these two hydraulic pumps to deliver a flow rate in order to supply respectively the primary circuit 100 and the secondary circuit 200.

The system as proposed is also reversible, and makes it possible to perform an energy recovery function during the shutdown of the secondary circuit 200 as explained below.

Advantageously, the primary motor M can have a generator operation during the shutdown of the secondary circuit 200. When it is desired to stop the secondary circuit 200, the primary motor M is monitored to provide a resistive torque. The vibrating elements 225 and 235 will temporarily continue to rotate due to their inertia. They will thus drive in rotation the hydraulic motors 220 and 230, which will then have a hydraulic pump operation and generate a flow rate. This flow rate will supply the secondary pump 210, which will then have a hydraulic motor operation and drive in rotation the shaft 10 of the primary motor M, which will then perform an electric generator function for charging a current storage means 450, for example an electric accumulator such as a battery. Thus, all or part of the energy of the vibrating elements is recovered during the braking.

The system as proposed also comprises a controller 20, typically a computer or an electronic control unit commonly referred to by the acronym ECU.

The controller 20 is adapted to pilot the primary motor M so as to provide sufficient torque to drive in rotation the primary pump 110 and the secondary pump 210 so as to achieve desired performances in terms of movement and vibration speed. Generally, the electric primary motor M is piloted so as to provide sufficient torque to jointly drive in rotation the primary pump 110 and the secondary pump 210. To do so, the controller 20 adds up the displacement and speed requirements of the primary pump 110 and of the secondary pump 210. For example, by knowing the speed requirements of the motors 120, 130, 220 and 230, therefore the flow rate requirements in the primary 100 and secondary 200 circuits, the controller 20 determines the displacement of the primary 110 and secondary 210 pumps and the speed of the motor M. In this way, it pilots the motor M to provide power equal to the sum of the powers required for the primary 100 and secondary 200 circuits.

The piloting performed by the controller 20 is typically performed based on information and instructions applied by a user, in particular the desired movement speed and the desired vibration frequency.

Such a system is in particular advantageous in terms of cost, volume and weight compared to systems that require a separate motor for driving each pump. By using a single electric motor, for at least two pumps having different driving requirements, it makes it possible to reduce the cost by reducing the number of electric motors and their piloting, as well as it allows a very compact mounting if the pumps are coupled as closely as possible.

In operation, the primary motor M drives in rotation the primary pump 110 and the secondary pump 210. The modulation of the displacement of the hydraulic pumps 110 and 210, typically by the controller 20, makes it possible to vary the flow rate delivered in the primary circuit 100 and in the secondary circuit 200. As a variant, the primary pump 110 is a manually-controlled pump. A displacement sensor then provides a displacement value to the controller 20 so that it pilots the secondary pump 210 as a function in particular of the displacement and of the direction of rotation of the primary pump 110. As a variant, a control law for the secondary pump 210 makes it possible to know with sufficient accuracy the displacement obtained as a function of the instruction applied to the control of the secondary pump 210. It is then possible, for example, to use a position sensor on a control lever actuated by the user to determine the displacement. A proportional electrical control can also be used, with the pump control inputs communicated to the controller 20. The secondary circuit 200 can for example be actuated beyond a threshold value of the movement speed of the movement members.

The system typically comprises a booster circuit 300. The booster circuit 300 as represented in the figures comprises a booster pump 310 adapted to deliver a booster flow rate.

Optionally, the booster pump 310 can be coupled to the shaft 10 of the primary motor M or via belts, a chain or gears so as to be driven in rotation jointly with the primary pump 110 and the secondary pump 210, in the same manner as the driving between the primary pump 100 and the secondary pump 210, or the booster pump 310 can be driven in rotation by another source, for example by another motor.

The booster circuit 300 typically comprises elements adapted in particular to take a pilot pressure allowing the piloting of different hydraulic members, and so as to define a booster pressure. These elements are generally designated by the numerical reference 315, the details of these elements not being the object of the invention.

The booster circuit 300 is connected to the primary circuit 100 and to the secondary circuit 200 via safety blocks, respectively 150 and 250.

Each safety block 150 and 250 performs an overpressure protection function and booster function of the associated hydraulic circuit, and optionally a function of purging the associated hydraulic circuit. Thus, for the safety block 150, a booster member 152 and a relief member 154 are defined, and for the safety block 250, a booster member 252 and a relief member 254 are defined. Each booster member 152 and 252 typically comprises one or more non-return flaps and calibrated valve elements forming a pressure limiter adapted to perform boostering to the intake of the associated hydraulic pump 110 or 210, as well as overpressure protection.

Each safety block 150 and 250 thus ensures a minimum pressure in the primary circuit 100 and the secondary circuit 200 via the booster members 152 and 252 as soon as the booster pump 310 is actuated, and performs a pressure relief when the pressure in one of these primary 100 or secondary 200 circuits exceeds a calibration value via the relief members 154 and 254. For example, the relief member 154 associated with the primary circuit 100 can be calibrated to a pressure of the order of 350 bar, and the relief member 254 associated with the secondary circuit 200 can be calibrated to a pressure of the order of 210 bar. These pressures depend on the components chosen for each primary or secondary circuit.

Each relief member 154 and 254 typically comprises a calibrated valve element or valve, configured so as to perform a fluid exhaust as soon as the pressure in one of the ducts of the associated circuit exceeds the calibration threshold value. This fluid exhaust can for example be directed from a duct described as high-pressure duct of the circuit to a duct described as low-pressure duct of the circuit, or to the reservoir R. The calibration value of each calibration member 154 and 254 is typically defined as a function of the pressures permissible by the different components of the primary 100 and secondary 200 hydraulic circuits, in particular as a function of the maximum pressures permissible by the hydraulic motors 120, 130, 220 and 230.

Optionally, the primary motor M and the secondary pump 210 can be piloted, typically via the controller 20, so that the pressure in the secondary circuit 200 remains lower than the calibration pressure of the relief member, whether during the commissioning of the system, during its operation or during its shutdown.

Such piloting makes it possible to avoid losses, in particular during the commissioning and shutdown of the secondary circuit 200, which could result from an overpressure in the secondary circuit and from a heating of the fluid in the secondary circuit 200.

According to one example, the controller 20 pilots the speed of the motor M and the displacement of the primary 110 and secondary 210 pumps to perform accelerations so as not to exceed an acceleration limit value. Particularly, the controller 20 can manage a start-up of the machinery comprising an acceleration of the traction together with an acceleration of the vibrating elements. It can also generate the launch of the controlled acceleration vibrating elements, while maintaining a constant forward speed of the machinery. To do so, the controller 20 determines at each instant an operating point of the primary motor M which makes it possible to provide the necessary power, in pressure and flow rate, for driving the primary pump 110 and the secondary pump 210, and possibly by taking into account the driving of the booster pump. If necessary, the primary motor M can be accelerated. The controller 20 changes the displacement of the primary pump 110 and of the secondary pump 210 accordingly, for example to maintain the constant forward speed, and the desired vibration acceleration. Generally, the controller 20 can change the speed of the primary motor M and the displacements of the primary pump 110 and of the secondary pump 210 according to the pressure and flow rate requirements of each circuit 100, 200, 300.

As a variant, for a simple and economical embodiment, the primary pump 110 is a manually-controlled hydraulic pump. In this way, a user can manually adjust the forward speed of a compactor that remains constant during work, i.e. the controller 20 adjusts the regime of the primary motor M to a fixed value, which makes it possible to obtain a constant forward speed. The controller 20 then changes the displacement of the secondary pump 210 to obtain the desired vibration acceleration.

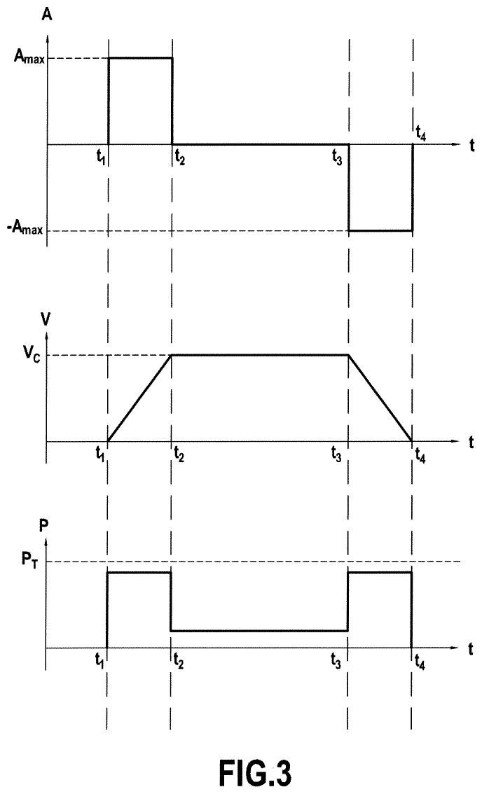

FIG. 3 shows several curves that illustrate the evolution of different parameters as a function of such piloting that maintains a pressure in the secondary circuit 200 lower than the calibration pressure of the relief member 254 via piloting of the rotational speed of the primary motor M and of the displacement of the secondary pump 210, it being understood that these curves are also transposed for the piloting of the primary circuit 100.

This figure represents an evolution of the acceleration A of the primary motor M as a function of time t, an evolution of the rotational speed V of the primary motor M as a function of time t, and an evolution of the pressure P within the vibration circuit 200 as a function of time t in the high-pressure duct of the vibration circuit 200.

The instant t1 designates the sending of a command to commission the vibration circuit 200. At this instant, the primary motor M is then rotated to reach a target speed Vc. The acceleration of the primary motor M is typically constant and equal to a maximum permissible acceleration value Amax which makes it possible to maintain a pressure P in the high-pressure duct of the hydraulic circuit strictly lower than the calibration pressure Pt of the relief member 254. The rotational speed V of the primary motor M2 then increases regularly, according to a constant slope. When the target speed Vc is reached, the acceleration becomes zero. The speed is maintained at the target speed Vc, and the pressure in the circuit is set to a substantially constant value making it possible to maintain the rotational speed while compensating for the various head losses and friction.

The instant t3 designates the sending of an instruction to shutdown the vibration circuit 200. The system then aims to bring the speed to a zero value as quickly as possible. The primary motor M is therefore braked, with a constant deceleration equal to a maximum permissible deceleration value, for example—Amax. This maximum permissible deceleration value is dimensioned so that the pressure in the high-pressure line of the vibration circuit 200 remains lower than the calibration pressure Pt of the relief member 254. It is noted here that the low-pressure line and the high-pressure line are reversed between the acceleration phase and the deceleration phase. The rotational speed of the primary motor M then decreases regularly, according to a constant slope, until its shutdown at the instant t4.

Optionally, the controller 20 can pilot the motor M by taking into account the power and speed requirements of the booster pump 300, at the same time as it takes into account the requirements of the primary 110 and secondary 210 pumps. For example, if during certain phases, the booster requirement increases, for example during the acceleration and pressure rise phases, then the primary motor M can be accelerated to increase the booster flow rate, while adjusting the displacement of the primary 110 and secondary 210 pumps to maintain the requested speeds.

Optionally, the controller 20 is configured to pilot the primary motor M, the primary pump 110 and the secondary pump 210 so that the vibrating elements are driven in the same direction of rotation as the movement members. Indeed, the vibrating elements are often carried by a rotation axis including bearings, which are themselves carried by the interior of the roller. In this way, the relative speed of the bearings is reduced, which reduces the friction, the losses in the bearings of the vibrating masses, and the force of the driving of the vibrating masses participates in the driving of the roller of the compactor in order to improve its commissioning. This also reduces wear on the bearings. This contributes to saving energy and increasing the autonomy of the machine. Such embodiment can in particular be applied by the controller 20 in a working configuration of the system with a demand for vibrations.

In the case of a simplified manually controlled circuit of the primary pump 110, a forward direction sensor allows the controller 20 to know the direction of rotation.

It is thus possible to pilot, typically via the controller 20, the displacement of the primary pump 110 and/or the displacement of the secondary pump 210.

Optionally, the system comprises a braking member 330 disposed at a discharge of the booster pump 310. The braking member 330 is typically a valve adapted to be in the on-state or to define a variable restriction at the discharge of the booster pump 310. Thus, the braking member 330 makes it possible to selectively generate a resistive torque on a shaft of the motor driving in rotation the booster pump 310, typically the primary motor M which also drives in rotation the primary pump 110 and the secondary pump 320 via the shaft 10. The braking member 330 is then typically piloted by the controller 20. The braking member 330 is typically a flow rate limiter having a fixed adjustment, strictly greater than a predetermined flow rate corresponding for example to a flow rate corresponding to normal or nominal use of the booster circuit 300. Thus, in the event of malfunction during braking of the vibrating elements or of the movement members, the inertia will tend to accelerate the hydraulic machines and the primary motor M while the displacements will have been reduced. This will lead to an increase in the flow rate delivered by the booster pump 310 which will then engage the flow rate limiter. Thus, in such embodiment, the piloting of the braking member 330 by the controller is not required, the triggering threshold being defined by the dimensioning of the braking member 330.

The use of such a braking member 330 makes it possible in particular to apply a braking torque, and thus to perform an energy dissipation function when storage means such as batteries are already charged during the braking and can therefore no longer ensure the motor brake function. The controller 20 is thus typically adapted to determine the state of charge of the current storage member 450, and to condition the actuation of the braking member 330 on the detection of a state of charge of the current storage member 450 greater than a predetermined threshold value, typically greater than or equal to 90%, greater than or equal to 95%, or equal to 100%. Thus, when the current storage member 450 has a state of charge lower than said threshold value, the energy is dissipated by the primary motor M which is driven so as to restore energy and charge of the current storage member 450. When the current storage member 450 has a state of charge greater than or equal to said threshold value, the latter can no longer be used to perform an energy dissipation function. The controller 20 then typically actuates the braking member 330.

The proposed system and method thus make it possible to optimize the energy dissipation while maintaining an energy and charge recovery function of the current storage member 450. In addition, the proposed system and method make it possible to perform continuous braking without using the vibrating elements for the energy dissipation function which are likely to generate undesirable vibrations.

According to one example, for a monitoring as simplified as possible, the braking member 330 can also be of the pressure-compensated flow rate limiter type, that is to say it will act automatically when the flow rate threshold for which it is calibrated is exceeded, without intervention of the controller 20. In such embodiment, it is therefore understood that the primary pump 110 is not necessarily piloted by the controller 20.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and the drawings should be considered in an illustrative rather than restrictive sense.

It is also obvious that all the characteristics described with reference to one method are transposable, alone or in combination, to one device, and conversely, all the characteristics described with reference to one device are transposable, alone or in combination, to one method.

1. A system for driving a compactor, comprising:
a primary hydraulic circuit adapted to perform a rotation of movement members of the compactor, said movement members comprising at least one roller, said primary hydraulic circuit comprising a primary pump adapted to supply the primary hydraulic circuit,
a secondary hydraulic circuit is adapted to perform a rotation of vibrating elements adapted to generate vibrations, the secondary hydraulic circuit comprising a secondary pump adapted to supply the secondary hydraulic circuit,
an electric primary motor adapted to jointly drive in rotation the primary pump and the secondary pump,
wherein
the primary pump and the secondary pump are variable displacement hydraulic pumps,
the system comprises a controller, adapted to pilot the primary motor so as to provide sufficient torque to drive the primary pump and the secondary pump.

2. The system according to claim 1, wherein
the primary hydraulic circuit is a closed-loop circuit,
the secondary hydraulic circuit is a closed-loop circuit.

3. The system according to claim 1, wherein the secondary hydraulic circuit comprises a calibrated relief member, adapted to perform a pressure relief from a duct of the secondary hydraulic circuit to a duct of the secondary hydraulic circuit having a lower pressure or to a reservoir, said calibration member being in the on-state when the pressure is greater than or equal to a calibration pressure,
and wherein the controller is configured to pilot the primary motor and the secondary pump such that the pressure in the secondary circuit remains lower than the calibration pressure.

4. The system according to claim 3, wherein the controller is configured to pilot the primary motor and the secondary pump such that the pressure in the secondary circuit remains lower than the calibration pressure while maintaining a constant movement speed of the compactor.

5. The system according to claim 1, wherein the controller is configured to pilot the primary motor, the primary pump and the secondary pump such that the vibrating elements are driven in the same direction of rotation as the movement members.

6. The system according to claim 1, wherein the controller is configured to pilot the rotational speed of the primary motor, the displacement of the primary pump and the displacement of the secondary pump.

7. The system according to claim 1, further comprising a booster pump adapted to supply a booster circuit, the primary motor being adapted to drive in rotation the booster pump together with the primary pump and the secondary pump.

8. The system according to claim 7, comprising a braking member disposed at a discharge of the booster pump, the braking member being adapted to be in the on-state or to define a restriction at the discharge of the booster pump, so as to generate a resistive torque on a shaft of the primary motor driving in rotation the booster pump, the primary pump and the secondary pump.

9. The system according to claim 8, wherein the braking member is a flow rate limiter having a fixed adjustment defining a flow rate beyond which it is in the on-state, said adjustment being set to a value greater than a pressure value corresponding to nominal operation of the system.

10. The system according to claim 8, further comprising a current storage member adapted to supply the primary motor, wherein the controller is configured so as to determine a state of charge of the current storage member, and to condition the actuation of the braking member on the detection of a state of charge of the current storage member greater than a predetermined threshold value.

11. A method for piloting a system comprising:
a primary hydraulic circuit adapted to drive in rotation movement members of a compactor comprising at least one roller, said primary hydraulic circuit comprising a variable displacement hydraulic primary pump,
a secondary hydraulic circuit adapted to drive in rotation vibrating elements to generate vibrations, said secondary hydraulic circuit comprising a variable displacement hydraulic secondary pump,
an electric primary motor, adapted to jointly drive in rotation the primary pump and the secondary pump,
wherein the primary motor is piloted so as to provide sufficient torque to jointly drive in rotation the primary pump and the secondary pump.

12. The method according to claim 10, wherein the rotational speed of the primary motor, the displacement of the primary pump and the displacement of the secondary pump are piloted.

13. The method according to claim 10, wherein the primary motor is piloted so that the pressure in the secondary hydraulic circuit remains lower than a calibration pressure of a relief member, said relief member being adapted to be in the on-state and to perform a pressure leak when the pressure in the secondary hydraulic circuit is higher than said calibration pressure.

14. The method according to claim 10, wherein the primary motor is also piloted so as to drive in rotation a booster pump of a booster circuit jointly with the primary pump and the secondary pump.

15. The method according to claim 13, wherein a braking member is provided at the discharge of the booster pump, so as to selectively generate a resistive torque on the primary motor.

16. The method according to claim 14, wherein the braking member is a flow rate limiter having a fixed adjustment defining a flow rate beyond which it is in the on-state, and wherein said adjustment is set to a value greater than a pressure value corresponding to nominal operation of the system.

17. The method according to claim 15, wherein the primary motor is connected to a current storage member adapted to supply the primary motor,
and wherein the controller determines a state of charge of the current storage member, and conditions the actuation of the braking member on the detection of a state of charge of the current storage member greater than a predetermined threshold value.
